(19) United States
(12) Patent Application Publication
(10) Pub. No.: US 2016/0134887 A1
(43) Pub. Date: May 12, 2016

(54) VIDEO ENCODING APPARATUS, VIDEO ENCODING METHOD, VIDEO DECODING APPARATUS, AND VIDEO DECODING METHOD

(71) Applicant: FUJITSU LIMITED, Kawasaki-shi (JP)

(72) Inventors: Kimihiko KAZUI, Kawasaki (JP); Akira NAKAGAWA, Sagamihara (JP); Guillaume Denis Christian Barroux, Kawasaki (JP)

(73) Assignee: FUJITSU LIMITED, Kawasaki-shi (JP)

(21) Appl. No.: 14/997,050

(22) Filed: Jan. 15, 2016

Related U.S. Application Data
(63) Continuation of application No. PCT/JP2013/069331, filed on Jul. 16, 2013.

(51) Int. Cl. H04N 19/52; H04N 19/44; H04N 19/91; H04N 19/176; H04N 19/136

(52) U.S. Cl. CPC H04N 19/52; H04N 19/176; H04N 19/136; H04N 19/91; H04N 19/44

(57) ABSTRACT

A video encoding apparatus determines, when the picture type of a picture to be encoded matches the picture type of at least one of reference pictures, a prediction value candidate for the motion vector of a block to be encoded from among the motion vectors of a plurality of already encoded blocks in the picture being encoded and the motion vector of a block contained in the at least one reference picture and having a predefined positional relationship to the block to be encoded, but when the picture type of the picture to be encoded does not match the picture type of any one of the reference pictures, determines the prediction value candidate for the motion vector of the block to be encoded from among the motion vectors of a plurality of already encoded blocks in the picture being encoded.

### CROSS-REFERENCE TO RELATED APPLICATION

This application is a continuation application and is based upon PCT/JP2013/069331, filed on Jul. 16, 2013, the entire contents of which are incorporated herein by reference.

### FIELD

The present invention relates, for example, to a video encoding apparatus and video encoding method for encoding video data by inter-predictive coding and a video decoding apparatus and video decoding method for decoding video data encoded by inter-predictive coding.

### BACKGROUND

Generally, the amount of data used to represent video data is very large. Accordingly, an apparatus handling such video data compresses the video data by encoding before transmitting the video data to another apparatus or before storing the video data in a storage device. Typical video coding standards widely used today include Moving Picture Experts Group Phase 2 (MPEG-2), MPEG-4, and H.264 MPEG-4 Advanced Video Coding (MPEG-4 AVC/H.264) developed by the International Standardization Organization/International Electrotechnical Commission (ISO/IEC). A new video coding standard referred to as HEVC (High Efficiency Video Coding, MPEG-H/H.265) is also under development (for example, refer to JCTVC-L1003, “High Efficiency Video Coding (HEVC) text specification draft 10 (for FDIS & Consent),” Joint Collaborative Team on Video Coding of ITU-T SG16 WP3 and ISO/IEC JTC1/SC29/WG11, January 2013—hereinafter referred to as non-patent document 1).

These coding standards employ an inter-predictive coding method which encodes a picture by using information from a previously encoded picture and an intra-predictive coding method which encodes a picture by using only information from itself.

In the HEVC standard, a motion vector prediction technique referred to as AMVP (Advanced Motion Vector Prediction) is introduced in order to efficiently encode motion vectors (MVs) which are important parameters in the inter-predictive coding method. In AMVP, the motion vectors of blocks spatially or temporally adjacent to the block to be encoded are selected as motion vector prediction value candidates. Then, video encoding apparatus selects from among the candidates one candidate as the motion vector prediction value, and includes a flag explicitly indicating the selected one into a data stream generated by encoding the video data.

Referring to FIG. 1, a description will be given of the blocks having motion vectors that can become motion vector prediction value candidates. Regions A0 and A1 located to the lower left of a target block 110 contained in the current picture 101 to be encoded are set in this order from the bottom, and regions B0 and B1 located to the upper right are set in this order from the right. Further, a region B2 is set which is adjacent to the upper left corner of the target block 110. When either the block containing the region A0 or the block containing the region A1 is already encoded, and when the block is an inter-predictive encoded block, then the motion vector of the block is selected as a first motion vector prediction value candidate. Likewise, when either the block containing the region B0 or the block containing the region B1 or the block containing the region B2 is already encoded, and when the block is an inter-predictive encoded block, then the motion vector of the block is selected as a second motion vector prediction value candidate.

Further, a motion vector prediction value candidate is selected from a picture 102 which was encoded earlier than the current picture 101. The picture from which the motion vector prediction value candidate is selected is referred to as the col picture. The details of the col picture will be described later. In the col picture 102, when either a block containing a region T0 adjacent to a block 111 located in the same position as the target block 110 or a block containing a region T1 located in the center of the block 111 is an inter-predictive encoded block, then the motion vector of the block is selected as a third motion vector prediction value candidate. The block contained in the col picture and having a motion vector selected as the third motion vector prediction value candidate is referred to as the col block.

In AMVP, the candidate to be used as the motion vector prediction value for the target block from among the motion vector prediction value candidates is specified using two parameters, MvpL0Flag (for a motion vector in direction L0) and MvpL1Flag (for a motion vector in direction L1). The direction L0 is, for example, a direction that points forward in display order from the current picture, and the direction L1 is, for example, a direction that points backward in display order from the current picture. Conversely, the direction L0 may be a direction that points backward in display order from the current picture, and the direction L1 may be a direction that points forward in display order from the current picture.

MvpL0Flag and MvpL1Flag take a value “0” or “1”. When the value is “0”, MvpL0Flag and MvpL1Flag indicate that the first motion vector prediction value candidate is to be used as the motion vector prediction value. On the other hand, when the value is “1”, MvpL0Flag and MvpL1Flag indicate that the second motion vector prediction value candidate is to be used as the motion vector prediction value. When the first motion vector prediction value candidate or the second motion vector prediction value candidate is invalid, i.e., when the video encoding apparatus is unable to refer to the motion vector of the block spatially adjacent to the target block, the third motion vector prediction value candidate is used. For example, when the first motion vector prediction value candidate is invalid, then the second motion vector prediction value candidate and the third motion vector prediction value candidate are regarded as the first motion vector prediction value candidate and the second motion vector prediction value candidate, respectively. Accordingly, in this case, when the value of MvpL0Flag and MvpL1Flag is “1”, the third motion vector prediction value candidate is selected as the motion vector prediction value.

Next, the col picture will be described with reference to FIG. 2.

Pictures 201 to 205 are pictures contained in video data to be encoded, and the pictures are arranged in display order. Among these pictures, the picture 203 (Curr) is the current picture to be encoded. The pictures 201 and 202 are respectively a forward reference picture (LOW) two pictures before the current frame 203 and a forward reference picture (L0[0]) one picture before. On the other hand, the pictures 204 and 205 are respectively a backward reference picture (L1[0]) one picture after the current picture 203 and a backward reference picture (L1[1]) two pictures after. In FIG. 2, the display times of the pictures 201 to 205 are represented by TL0[1], TL0[1], TCurr, TL1[0], and TL[1], respectively.

The illustrated example is only one example, and any number of forward reference pictures and any number of backward reference pictures can be set for the current picture, provided that the number does not exceed the upper limit specified by the standard. Further, the backward reference pictures may precede the current picture in display time.

In MPEG-4 AVC/H.264, the col picture is fixed to the 0th reference picture L1[0] in the backward reference picture list L1[ ]. On the other hand, in HEVC, the col picture is arbitrarily specified from among the forward reference pictures or the backward reference pictures.

In this case, the slice header of the encoded data of the current picture Curr includes parameters CollocatedFromL0Flag and CollocatedRefIdx. The col picture is specified by these parameters. For example, when the parameter CollocatedFromL0Flag is “1”, the picture specified by L0[CollocatedRefIdx] from the forward reference picture list L0[ ] is the col picture. On the other hand, when the parameter CollocatedFromL0Flag is “0”, the picture specified by L1[CollocatedRefIdx] from the backward reference picture list L1[ ] is the col picture.

The time difference between the col picture and the picture to which the motion vector of the col block refers may be different from the time difference between the picture to be encoded and the picture to which the motion vector of the block to be encoded refers. As a result, when the motion vector of the col block is selected as the motion vector prediction value, the scale of the selected motion vector has to be adjusted.

Referring to FIG. 3, a description will be given of how the scaling of the selected motion vector is performed when the motion vector of the col block, i.e., the third motion vector prediction value candidate, is selected as the motion vector prediction value.

In FIG. 3, the abscissa represents the display time of each picture, and the ordinate represents the vertical position of each picture. Block 301 is the current block being encoded, and block 302 is the col block. The current block 301 is contained in the current picture (Curr) 312 being encoded, and the col block 302 is contained in the col picture (Col) 313. Pictures 310 and 311 are respectively the picture (RefCurr) to which the current block 301 refers and the picture (RefCol) to which the col block 302 refers. The display times of the pictures 310 to 313 are represented by TRefCurr, TRefCol, TCurr, and TCol, respectively.

When it is assumed that the motion of an object located in corresponding positions in the respective pictures is constant, the vertical component 321 of the motion vector of the current block 301 agrees with the vertical component 320 of the motion vector of the col block 302. On the other hand, the current block 301 refers to the picture RefCurr. Therefore, when the motion vector of the col block is to be used as the motion vector prediction value for the current block 301, the length in the time direction of the motion vector of the col block is adjusted in accordance with the ratio of the time difference between the current picture Curr and the reference picture RefCurr to the time difference between the col picture Col and the reference picture RefCol.

More specifically, the time difference between the col picture Col and the reference picture RefCol is denoted by ΔCol=(TRefCol−TCol), and the time difference between the current picture Curr and the reference picture RefCurr by ΔCurr=(TRefCurr−TCurr). Then, the motion vector prediction value MVPred for the current block is given by MVPred=MVCol*ΔCurr/ΔCol. As a result, the vertical component of the motion vector prediction value MVPred is indicated by arrow 322.

### SUMMARY

The HEVC standard also supports interlaced video. Referring to FIG. 4, a description will be given of how interlaced video is generated. In FIG. 4, the abscissa represents the display time, and the ordinate represents the vertical position of each picture. Interlaced video includes two fields, the top field (401, 403, 405) and the bottom field (402, 404, 406), and the top field and the bottom field are displayed in alternating fashion.

The vertical position of each pixel line 410 in the top field is displaced relative to the vertical position of the corresponding pixel line 411 in the bottom field by one half pixel in the vertical direction of the field, i.e., by one pixel in the frame.

Next, a problem associated with AMVP in interlaced video will be described with reference to FIG. 4.

The pictures 402, 404, and 405 are designated as the picture (RefCurr) to which the current block being encoded refers, the current picture (Curr), and the Col picture (Col), respectively. The display times of the pictures 402, 404, and 405 are represented by TRefCurr, TCurr, and TCol, respectively. Further, the picture 404 is also designated as the reference picture (RefCol) for the col block.

The vertical component 420 of the motion vector of the col block is assumed to be 2. The col picture 405 constitutes the top field, while the reference picture 404 for the col picture constitutes the bottom field. Therefore, in actuality, the vertical position pointed to by the vertical component 420 of the motion vector of the col block is displaced relative to the vertical position of the col block by two and a half pixels in the field.

On the other hand, a vector 421 whose base point is located at the upper end position of the current block is generated by translating and extending the vector 420 so that TRefCurr becomes the reference picture. The difference from the base point to the end point of the vector 421 as measured in the vertical direction is “5”. When the vector 420 is selected as the motion vector prediction value, it is preferable that the adjusted motion vector prediction value becomes as indicated by the vector 421 by the AMVP scaling process.

However, when the vector 420 is scaled in accordance with AMVP in HEVC, a vector 422 is obtained whose difference between the base point and the end point is “4”. This is because the value of the vertical component of the vector 420 itself is “2”, and because the time difference, ΔCurr=(TRefCurr−TCurr), between the picture Curr and its reference picture RefCurr is 2 and the time difference, ΔCol=(TRefCol−TCol), between the col picture Col and its reference picture RefCol is 1. In other words, the vertical component of the scaled vector 422 is MVCol*ΔCurr/ΔCol=4.

As described above, in the case of interlaced video, there arises the problem that the motion vector prediction value computed from the third motion vector prediction value candidate by AMVP may not be accurate.

In the method disclosed in JCTVC-G196, “Modification of derivation process of motion vector information for interlace format,” Joint Collaborative Team on Video Coding of ITU-T SG16 WP3 and ISO/IEC JTC1/SC29/WG11, November 2011 (hereinafter referred to as non-patent document 2), the problem is solved by introducing scaling that accounts for the parity of each of the pictures Curr, RefCurr, Col, and RefCol. The parity of the picture is “0” in the case of the top field and “1” in the case of the bottom field.

According to the method of non-patent document 2, before performing the time scaling of the motion vector of the col block used as the third motion vector prediction value candidate, the vertical component of the motion vector is corrected based on the parity of the picture Col and the parity of the picture RefCol. More specifically, first the video encoding apparatus adds 0.5*(isBottomRefCol−isBottomCol) to the vertical component of the motion vector of the col block. The designations isBottomRefCol and isBottomCol refer to the parity of the col block reference picture and the parity of the col picture, respectively. Next, after scaling the motion vector of the col block in accordance with the AMVP scaling method, the video encoding apparatus adds 0.5*(isBottomCurr−isBottomRefCurr). The designations isBottomCurr and isBottomRefCurr refer to the parity of the current picture and the parity of the current block reference picture, respectively.

In the example illustrated in FIG. 4, isBottomRefCol, isBottomCol, isBottomCurr, and isBottomRefCurr are respectively 1, 0, 1, and 1. Accordingly, when the vector 420 as the vertical component of the motion vector of the col block is scaled in accordance with the method of non-patent document 2, the result “5” is obtained as the vertical component of the motion vector prediction value.

The scaling method disclosed in non-patent document 2 is applicable to the case where all the pictures are field pictures. On the other hand, in the HEVC standard (first edition) disclosed in non-patent document 1, when encoding interlaced video, the video encoding apparatus can switch the picture to be encoded between a frame picture and a field picture on a sequence-by-sequence basis. When the amount of motion of the object contained in the picture is small, the frame picture generated by combining two field pictures is advantageous over the field picture in terms of coding efficiency. On the other hand, when the amount of motion of the object contained in the picture is large, the field picture is advantageous over the frame picture in terms of coding efficiency.

However, it is not possible to apply the scaling method disclosed in non-patent document 2 directly to video data in which the picture switches between a frame picture and a field picture on a picture-by-picture basis. The reason is that the method of computing the vertical position of each block and pixel is different for the frame picture than for the field picture.

Referring to FIG. 5, a description will be given of the case where the scaling method disclosed in non-patent document 2 is unable to be applied directly.

In FIG. 5, the abscissa represents the display time of each picture, and the ordinate represents the vertical position of each picture. In the illustrated example, pictures 501, 502, 505, and 506 are field pictures. On the other hand, picture 503 is a frame picture. It is assumed that the frame picture 503 is the current picture Curr to be encoded and that the field picture 505 is the col picture. It is also assumed that the field picture 501 is the reference picture RefCurr for the current block to be encoded and that the frame picture 503 is the reference picture RefCol for the col block.

The base point of the motion vector 521 of the current block is set at the topmost line in the current block. In the illustrated example, since the current picture 503 is a frame picture, the vertical position of the base point 510 is “2” (i.e., the third position from the top) in the frame picture. On the other hand, the position of the base point of the col block is the same as that of the base point of the motion vector of the current picture according to the HEVC standard disclosed in non-patent document 1, and is therefore located at the line 511 whose vertical position is “2”. However, since the col picture 505 is a field picture, the line 511 is displaced downward relative to the base point 510 by two in terms of the pixels in the frame picture. Normally, the desirable position of the base point of the col block is the first line 530 from the top in terms of the pixels in the field picture. This means that the video encoding apparatus has to change the col block position computation method according to the picture type (frame or field) of the current picture and the picture type of the col picture.

Suppose that the vector 520 is the correct third motion vector prediction value candidate. In this case, a motion vector parallel to the vector 520 is the desirable motion vector prediction value corresponding to the vector 521. The vertical component of the vector 521 is “2”. In the illustrated example, since the current picture 503 is a frame picture, the vertical component is computed on a frame-by-frame basis by regarding the field picture 501 serving as the reference picture and its ensuing field picture 502 as constituting one frame. However, according to the AMVP disclosed in non-patent document 1, since the col picture is a field picture, the vertical component of the motion vector prediction value is computed on a field-by-field basis, and is given as “1”. This means that the scale of the motion vector prediction value candidate selected as the motion vector prediction value needs to be adjusted according to the picture type of the current picture and the picture type of the col picture.

As described above, the scaling method disclosed in non-patent document 2 has the problem of being unable to be applied when the picture switches between a frame picture and a field picture on a picture-by-picture basis. This problem can be solved by discriminating picture type on a picture-by-picture basis and by changing the col block position computation and motion vector prediction value candidate computation method according to the result of the discrimination. However, when the computation method is changed in this way, there arises the problem that it is not possible to maintain compatibility between the motion vector predictive coding method for which the computation method has been changed and the AMVP method disclosed in non-patent document 1.

According to one embodiment, a video encoding apparatus for inter-predictive encoding, using a motion vector, a picture that is contained in video data and whose picture type is a frame or a field is provided. The video encoding apparatus includes a processor configured to: when the picture type of the picture to be encoded matches the picture type of at least one of reference pictures that are referred to when inter-predictive encoding the picture, determine that the motion vector of a block contained in the at least one reference picture and having a predefined positional relationship to a block to be encoded in the picture to be encoded is to be included as a prediction value candidate for the motion vector of the block to be encoded, on the other hand, when the picture type of the picture to be encoded does not match the picture type of any one of the reference pictures, determine that the motion vector of any block in any one of the reference pictures is not to be included as a prediction value candidate for the motion vector of the block to be encoded; determine, when the motion vector of a block contained in the at least one reference picture is included as a prediction value candidate for the motion vector of the block to be encoded, the prediction value candidate for the motion vector of the block to be encoded from among the motion vectors of a plurality of already encoded blocks in the picture being encoded and the motion vector of the block contained in the at least one reference picture and having the predefined positional relationship to the block to be encoded, on the other hand, determine, when the motion vector of a block contained in the at least one reference picture is not included as a prediction value candidate for the motion vector of the block to be encoded, the prediction value candidate for the motion vector of the block to be encoded from among the motion vectors of a plurality of already encoded blocks in the picture being encoded, and a candidate whose difference with respect to the motion vector of the block to be encoded is the smallest among the prediction value candidates for the motion vector of the block to be encoded is selected as the prediction value for the motion vector of the block to be encoded; generate selection information indicating the candidate that provides the prediction value and compute the difference between the prediction value and the motion vector of the block to be encoded; and entropy-encode the selection information and the difference between the prediction value and the motion vector of the block to be encoded.

According to another embodiment, a video decoding apparatus for decoding video data containing a picture that is inter-predictive encoded using a motion vector and whose picture type is a frame or a field is provided. The video decoding apparatus includes a processor configured to: decode entropy-encoded selection information that indicates a motion vector prediction value candidate that provides a prediction value for the motion vector of a block to be decoded; decode an entropy-encoded difference between the prediction value and the motion vector of the block to be decoded; when the picture type of the picture to be decoded, the picture containing the block to be decoded, matches the picture type of at least one of reference pictures that are referred to when inter-predictive encoding the picture to be decoded and that are decoded earlier than the picture to be decoded, determine that the motion vector of a block contained in the at least one reference picture and having a predefined positional relationship to the block to be decoded is to be included as a prediction value candidate for the motion vector of the block to be decoded, on the other hand, when the picture type of the picture to be decoded does not match the picture type of any one of the reference pictures, determine that the motion vector of any block in any one of the reference pictures is not to be included as a prediction value candidate for the motion vector of the block to be decoded; determine, when the motion vector of a block contained in the at least one reference picture is included as a prediction value candidate for the motion vector of the block to be decoded, the prediction value candidate for the motion vector of the block to be decoded from among the motion vectors of a plurality of already decoded blocks in the picture being decoded and the motion vector of the block contained in the at least one reference picture and having the predefined positional relationship to the block to be decoded, on the other hand, determine, when the motion vector of a block contained in the at least one reference picture is not included as a prediction value candidate for the motion vector of the block to be decoded, the prediction value candidate for the motion vector of the block to be decoded from among the motion vectors of a plurality of already decoded blocks in the picture being decoded; determine the candidate that provides the prediction value in accordance with the selection information from among the prediction value candidates for the motion vector of the block to be decoded; decode the motion vector of the block to be decoded by adding the difference between the prediction value and the motion vector of the block to be decoded to the candidate that provides the prediction value; and decode the block to be decoded by using the decoded motion vector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining spatially and temporally blocks according to an AMVP method.

FIG. 2 is a diagram for explaining a col block according to the AMVP method.

FIG. 3 is a diagram for explaining the scaling of a motion vector according to the AMVP method.

FIG. 4 is a diagram for explaining a problem that can arise when the AMVP method is applied to interlaced video.

FIG. 5 is a diagram for explaining a problem that can arise when the AMVP method is applied to video that contains both field and frame pictures.

FIG. 6 is a diagram for explaining an adverse effect that can occur when the application of temporal motion vector prediction is disabled.

FIG. 7 is a diagram schematically illustrating the configuration of a video encoding apparatus according to a first embodiment.

FIG. 8 is an operation flowchart of a motion vector predictive encoding process performed according to the first embodiment.

FIG. 9 is a diagram schematically illustrating the configuration of a video decoding apparatus according to the first embodiment.

FIG. 10 is an operation flowchart of a motion vector predictive decoding process performed according to the first embodiment.

FIG. 11 is an operation flowchart of a motion vector predictive encoding process performed according to a second embodiment.

FIG. 12 is an operation flowchart of a motion vector predictive decoding process performed according to the second embodiment.

FIG. 13 is a diagram illustrating the configuration of a computer that operates as a video encoding apparatus or video decoding apparatus by executing a computer program for implementing the function of each unit of the video encoding apparatus or video decoding apparatus according to any one of the embodiments or its modified example.

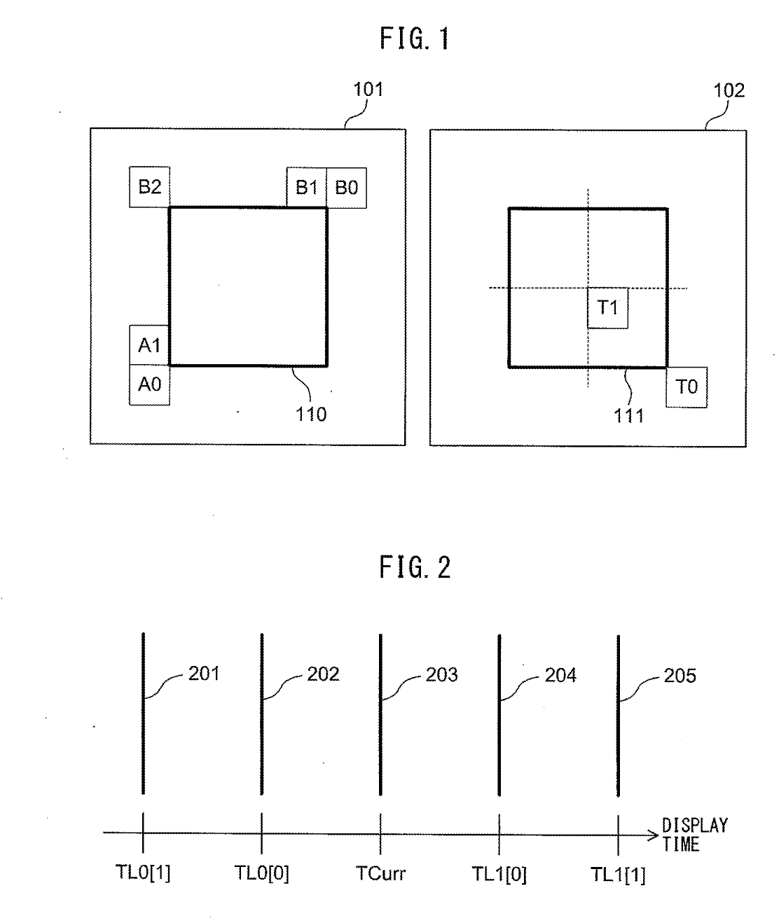

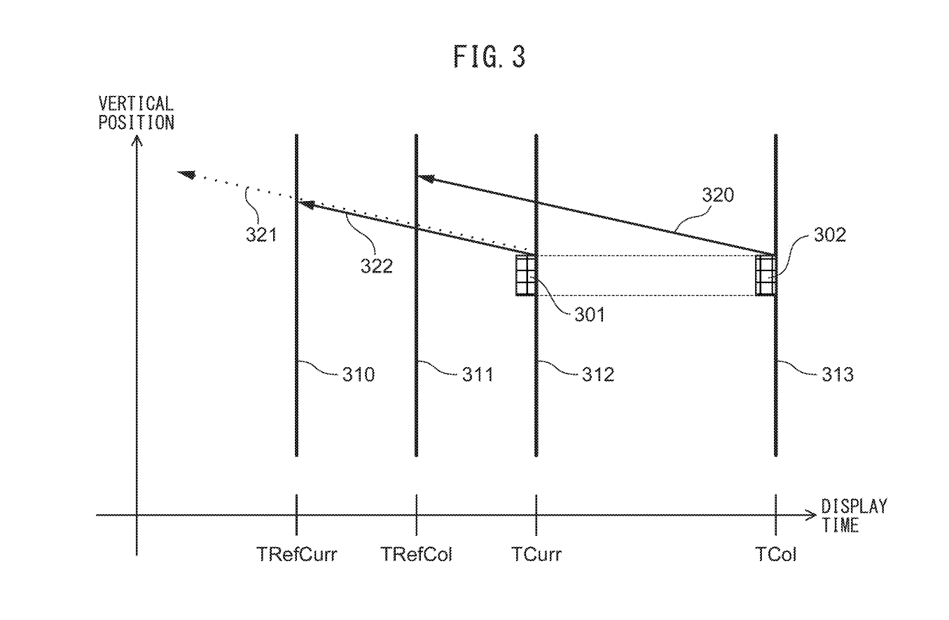

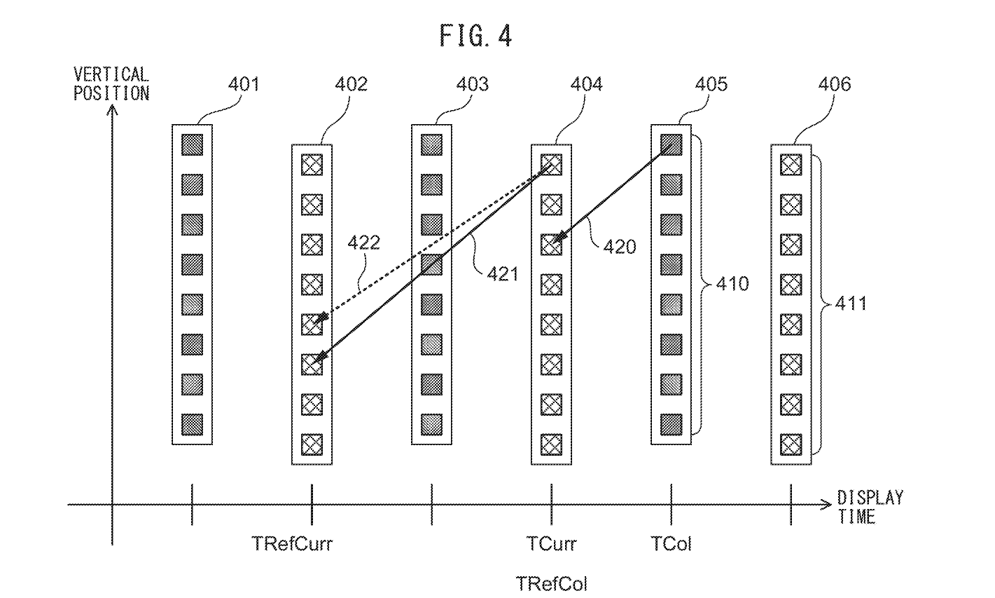

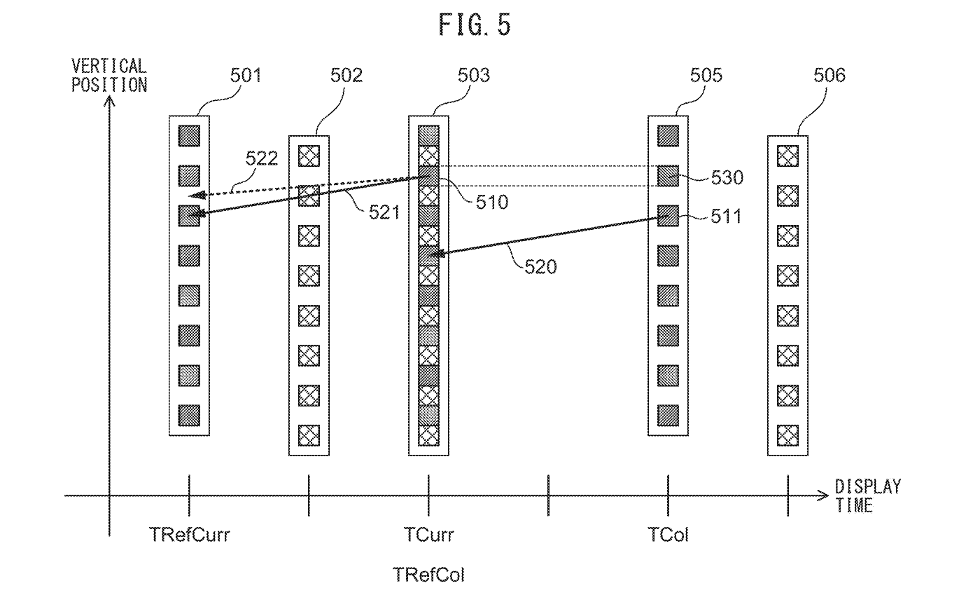

### DESCRIPTION OF EMBODIMENTS

A video encoding apparatus according to one embodiment will be described below with reference to the drawings. The video encoding apparatus is capable of encoding interlaced video by inter-predictive coding.

As earlier described, the scaling method disclosed in non-patent document 2 has the problem of being unable to be applied to the case where switching is made between a frame picture and a field picture on a picture-by-picture basis. In order to solve this problem while maintaining compatibility with the AMVP method disclosed in non-patent document 1, the video encoding apparatus according to the present embodiment utilizes a flag SliceTemporalMvpEnableFlag carried in a picture slice header as defined in the AMVP method. The flag SliceTemporalMvpEnableFlag is one example of application information which specifies whether the third motion vector prediction value candidate is to be applied or not. By setting the flag SliceTemporalMvpEnableFlag of a picture to “0”, the video encoding apparatus disables the application of temporal motion vector prediction to the picture, i.e., the application of the third motion vector prediction value candidate itself. On the other hand, by setting the flag SliceTemporalMvpEnableFlag of a picture to “1”, the video encoding apparatus enables the application of the third motion vector prediction value candidate to the picture.

The video encoding apparatus can disable the application on a picture-by-picture basis only when the picture type is different between the col picture and the current picture. However, when the application of the third motion vector prediction value candidate is disabled for a given picture, the disabling may affect pictures that follow the given picture in encoding order.

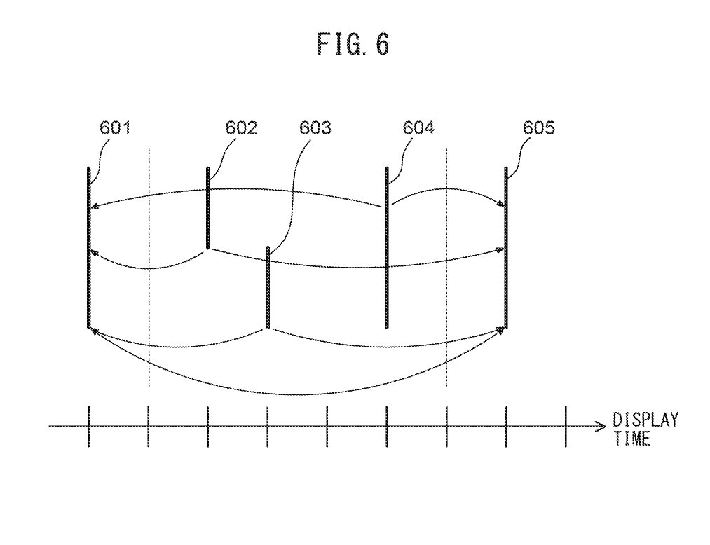

This problem will be described with reference to FIG. 6. In FIG. 6, the abscissa represents the display time. Pictures 601, 604, and 605 are frame pictures, and pictures 602 and 603 are field pictures. It is assumed that these pictures are encoded in the order of the pictures 601, 605, 602, 603, and 604. In FIG. 6, the base of each arrow indicates a picture that refers to another picture, and the head of the arrow indicates the picture that is referred to. For example, the picture 604 refers to the pictures 601 and 605.

The pictures 602 and 603 both refer to the pictures 601 and 605 which are both frame pictures. As a result, according to the method, the video encoding apparatus disables the application of the third motion vector prediction value candidate by setting the flag SliceTemporalMvpEnableFlag to “0” for both of the pictures 602 and 603.

However, according to the AMVP method disclosed in non-patent document 1, all the pictures to be encoded after the pictures 602 and 603 for which the flag SliceTemporalMvpEnableFlag has been set to “0” become unable to select the col picture from among the pictures encoded earlier than the pictures 602 and 603. The reason for this is to prevent the propagation of motion vector prediction errors.

For example, a technique referred to as intra-slice refresh is proposed that enables decoding to be started from an intermediate point in a bit stream without using an intra-picture in which all the blocks are intra-predictive encoded. This technique inserts an intra-predictive encoded block in each picture by changing the position of the intra-predictive encoded block in cyclic fashion such that the intra-predictive encoded block is inserted at every position in the picture in a predetermined cycle. By so doing, all the regions within the picture are intra-predictive encoded in a given period of time, thus making it possible to decode the entire picture normally. In intra-slice refresh, since each picture contains intra-predictive encoded blocks, when the third motion vector prediction value candidate can be used at all times, the motion vector becomes unable to be decoded normally in the picture serving as the decoding starting point and in any subsequent pictures. The picture serving as the decoding starting point is the picture at which the intra-slice cycling is started and, by starting the decoding from this picture, the subsequent pictures can be decoded normally. The picture serving as the decoding starting point appears in every cyclic period. To prevent the problem, the video encoding apparatus sets the flag SliceTemporalMvpEnableFlag to “0” in the picture serving as the decoding starting point so that not only the picture serving as the decoding starting point but also the subsequent pictures will not refer to the motion vector information of any picture earlier than the decoding starting point.

Suppose that, in the case of FIG. 6, the flag SliceTemporalMvpEnableFlag is set to “0” for both of the pictures 602 and 603. In this case, the picture 604 that follows the pictures 602 and 603 in encoding order becomes unable to select the picture 601 or 605, to which the picture 604 can refer and which is of the same picture type as the picture 604, as the col picture. As a result, the third motion vector prediction value candidate is not used for the picture 604, and the coding efficiency drops.

In view of the above, when the picture type is different between the current picture and the col picture, the video encoding apparatus according to the present embodiment disables the application of the third motion vector prediction value candidate only for the current picture. The video encoding apparatus also disables the application of the third motion vector prediction value candidate when there exists no reference picture that is later in encoding order than the decoding starting picture immediately preceding the current picture. Otherwise, the video encoding apparatus uses the third motion vector prediction value candidate for motion vector prediction.

In the present embodiment, each picture contained in the video signal may be a color video image or may be a monochrome video image.

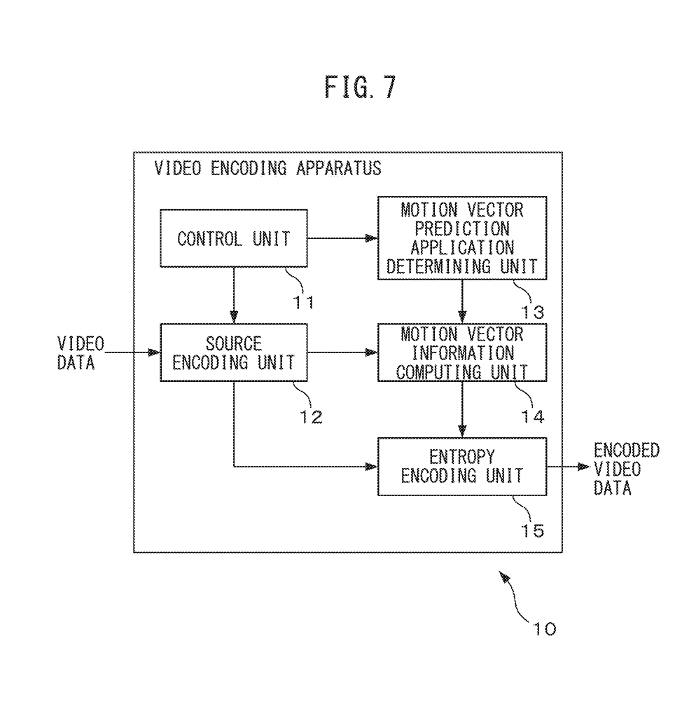

FIG. 7 is a diagram schematically illustrating the configuration of a video encoding apparatus according to a first embodiment. The video encoding apparatus 10 includes a control unit 11, a source encoding unit 12, a motion vector prediction application determining unit 13, a motion vector information computing unit 14, and an entropy encoding unit 15. These units of the video encoding apparatus 10 are implemented as separate circuits on the video encoding apparatus 10. Alternatively, these units of the video encoding apparatus 10 may be implemented on the video encoding apparatus 10 in the form of a single integrated circuit on which the circuits implementing the functions of the respective units are integrated. Further alternatively, these units of the video encoding apparatus 10 may be implemented as functional modules by executing a computer program on a processor incorporated in the video encoding apparatus 10.

The control unit 11 under control of an external device (not depicted) determines the encoding mode (inter-predictive encoding mode or intra-predictive encoding mode), encoding order, reference relation, and picture type (frame or field) for each picture.

The control unit 11 notifies the source encoding unit 12 of the encoding mode, reference relation, and picture type determined for the current picture. Further, the control unit 11 notifies the motion vector prediction application determining unit 13 of the encoding mode determined for the current picture, the encoding mode determined for the reference picture, and information indicating whether the reference picture is later than the decoding starting point or not.

The source encoding unit 12 applies source encoding (information source encoding) to each picture contained in the input video. More specifically, in accordance with the encoding mode selected for each picture, the source encoding unit 12 generates a prediction block for each block to be encoded in the current picture from an already encoded picture or from an already encoded region in the current picture. For example, when the current block is to be inter-predictive encoded in accordance with a forward prediction mode or backward prediction mode, the source encoding unit 12 computes a motion vector. The motion vector is computed, for example, by performing block matching between the reference picture obtained from a frame memory (not depicted) and the current picture. Then, the source encoding unit 12 applies motion compensation to the reference picture based on the motion vector. The source encoding unit 12 generates a prediction block to be used for motion-compensated inter-predictive encoding. The motion compensation is the process of finding a region in the reference picture that most closely resembles the block and moving the most closely resembling region in the reference picture in such a manner as to compensate for the positional displacement between the region and the block as represented by the motion vector.

When the current block is to be inter-predictive encoded in accordance with a bidirectional prediction mode, the source encoding unit 12 locates the regions in the reference pictures that are identified by two motion vectors, and applies motion compensation to the regions by using the respective motion vectors. Then, the source encoding unit 12 generates a prediction block by averaging the pixel values between the corresponding pixels in the two compensated images obtained by the motion compensation. Alternatively, the source encoding unit 12 may generate a prediction block by calculating a weighted average of the values of the corresponding pixels in the two compensated images by multiplying the pixel values by larger weighting coefficients as the time difference between the corresponding reference picture and the current picture becomes smaller.

On the other hand, when the current block is to be intra-predictive encoded, the source encoding unit 12 generates a prediction block from blocks adjacent to the current block to be encoded. Then, for each block to be encoded, the source encoding unit 12 calculates the difference between the block to be encoded and the prediction block. The source encoding unit 12 then generates a prediction error signal by taking the difference value obtained by the difference calculation for each pixel in the block.

The source encoding unit 12 obtains prediction error transform coefficients by applying an orthogonal transform to the prediction error signal of the current block. For example, the source encoding unit 12 may use Discrete Cosine Transform (DCT) as the orthogonal transform.

Next, the source encoding unit 12 obtains quantized prediction error transform coefficients by quantizing the prediction error transform coefficients. The quantization is a process for representing the signal values contained within a given section by one signal value. The size of this given section is referred to as the quantization step size. For example, the source encoding unit 12 quantizes the prediction error transform coefficients by dropping from each prediction error transform coefficient a predetermined number of low-order bits corresponding to the quantization step size. The source encoding unit 12 supplies the quantized prediction error transform coefficients to the entropy encoding unit 15.

Using the quantized prediction error transform coefficients of the current block, the source encoding unit 12 generates a reference picture to be referred to when encoding subsequent blocks. To that end, the source encoding unit 12 inverse-quantizes the quantized prediction error transform coefficients by multiplying with a predetermined number corresponding to the quantization step size. By this inverse quantization, the prediction error transform coefficients of the current block are reconstructed. After that, the source encoding unit 12 applies an inverse orthogonal transform to the prediction error transform coefficients. By applying the inverse quantization and inverse orthogonal transform to the quantized signals, the prediction error signal is reconstructed that has approximately the same information as the original prediction error signal.

The source encoding unit 12 adds, to the value of each pixel in the prediction block, the reconstructed prediction error signal corresponding to the pixel. By applying the above-described processing operations to each block, the source encoding unit 12 generates a reference block which is used to generate a prediction block for the block to be encoded thereafter. Then, the source encoding unit 12 decodes the reference picture, for example, by splicing the reference blocks in the encoding order. The source encoding unit 12 then stores the reference picture in the frame memory. The frame memory stores a predetermined number of reference pictures to which the picture to be encoded may refer; then, as the number of reference pictures exceeds the predetermined number, the reference pictures are discarded in the same order as they were encoded.

For each block that is to be inter-predictive encoded, the source encoding unit 12 also stores information concerning the motion vector of the block (for example, the horizontal and vertical components, i.e., the reference picture pointed to by the motion vector, the position of the block that refers to the reference picture, etc.) in the frame memory. Then, the source encoding unit 12 passes the motion vector information to the motion vector information computing unit 14.

The motion vector prediction application determining unit 13 determines whether or not the third motion vector prediction value candidate is to be used for motion vector encoding, based on the picture type of the current picture, the picture type of the reference picture, and the information indicating whether the reference picture is later than the decoding starting point or not. The motion vector prediction application determining unit 13 passes the result of the determination to the motion vector information computing unit 14.

The motion vector information computing unit 14 determines the motion vector prediction value by selecting the candidate whose error with respect to the motion vector passed from the source encoding unit 12 is the smallest from among the first, second, and third motion vector prediction value candidates. Then, the motion vector information computing unit 14 passes the difference value between the motion vector and the motion vector prediction value (hereinafter referred to as the motion vector prediction error) and an index (for example, parameters MvpL0Flag and MvpL1Flag) indicating the selected candidate to the entropy encoding unit 15.

When the result of the determination received from the motion vector prediction application determining unit 13 indicates that the third motion vector prediction value candidate is not to be used, the motion vector information computing unit 14 does not compute the motion vector from the third motion vector prediction value candidate, but determines the motion vector prediction value from among the first and second motion vector prediction value candidates.

The motion vector information computing unit 14 can determine, for example, in accordance with the AMVP method, the index which is one example of the selection information indicating the selected candidate. Accordingly, when either one of the first and second motion vector prediction value candidates is invalid, and when the third motion vector prediction value candidate is not to be used, the index is determined so as to indicate the first motion vector prediction value candidate or the second motion vector prediction value candidate, whichever is valid.

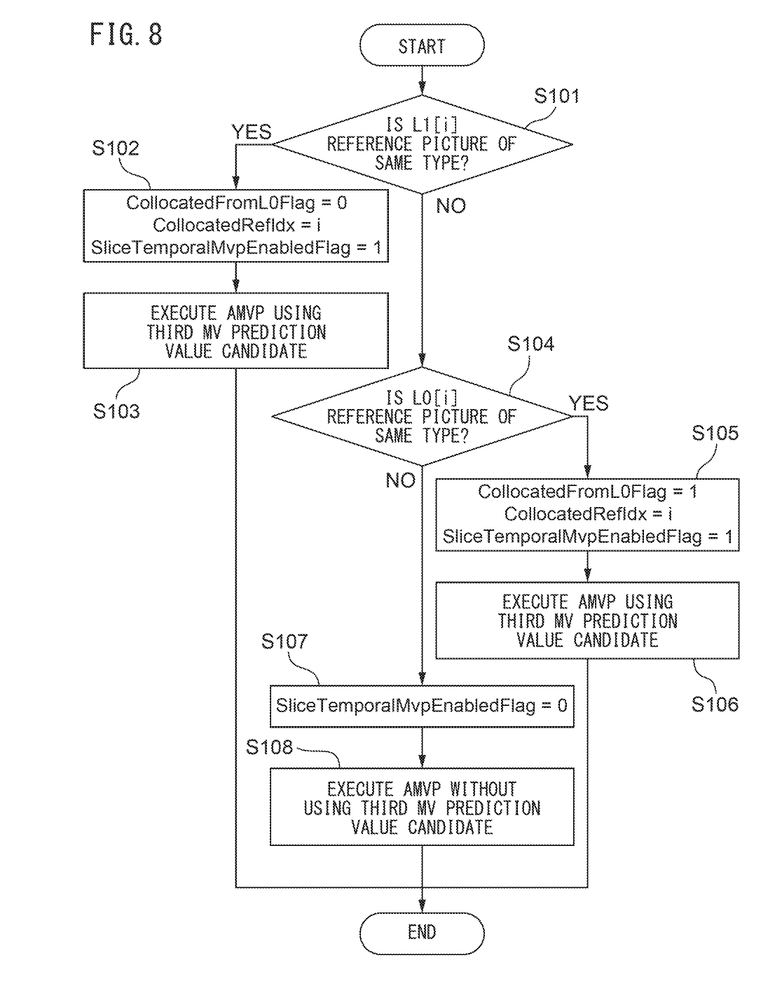

FIG. 8 is an operation flowchart of a motion vector predictive encoding process according to the first embodiment. The video encoding apparatus 10 predictive-encodes the motion vector in accordance with the operation flowchart of FIG. 8 for each picture to be inter-predictive encoded.

The motion vector prediction application determining unit 13 compares the picture type (frame or field) of the current picture with the picture type of each of the reference pictures located in the direction L1 as seen from the current picture. Further, the motion vector prediction application determining unit 13 examines the positional relationship between the picture serving as the decoding starting point and each of the reference pictures located in the direction L1 (step S101). When the picture type of at least one of the reference pictures in the direction L1 matches the picture type of the current picture, and when that reference picture is later in encoding order than the decoding starting picture immediately preceding the current picture (Yes in step S101), the motion vector prediction application determining unit 13 determines that the third motion vector prediction value candidate is to be used. Then, the motion vector prediction application determining unit 13 sets the parameter CollocatedFromL0Flag, which is carried in the slice header of the current picture and indicates the direction from which the col picture is to be selected, to “0” indicating that the col picture is to be selected from among the reference pictures located in the direction L1. Further, the motion vector prediction application determining unit 13 sets the parameter CollocatedRefIdx, which indicates the order among the reference pictures, to the minimum value min(RefIdex) of RefIndex to point to the picture nearest to the current picture in display order among the reference pictures of the same picture type as the current picture. In other words, the parameters CollocatedFromL0Flag and CollocatedRefIdx are one example of picture specifying information that specifies the col picture. Further, the motion vector prediction application determining unit 13 sets the parameter SliceTemporalMvpEnableFlag, which is one example of the application information indicating whether the third motion vector prediction value candidate is to be used or not, to the value “1” indicating that the third motion vector prediction value candidate is to be used (step S102). Then, the motion vector prediction application determining unit 13 passes the parameters CollocatedFromL0Flag, CollocatedRefIdx, and SliceTemporalMvpEnableFlag to the motion vector information computing unit 14 as the result of the determination indicating that the third motion vector prediction value candidate is to be used.

The motion vector information computing unit 14 predicts the motion vector by using the third motion vector prediction value candidate in accordance with the AMVP method for each block to be inter-predictive encoded in the current picture, and predictive-encodes the motion vector by computing the prediction error (Step S103). The motion vector information computing unit 14 passes the motion vector prediction error, selected candidate index, and SliceTemporalMvpEnableFlag to the entropy encoding unit 15. Then, the motion vector information computing unit 14 terminates the motion vector predictive encoding process.

When, in step S101, none of the reference pictures in the direction L1 match the picture type of the current picture, or when there are no reference pictures in the direction L1 that are later in encoding order than the decoding starting picture immediately preceding the current picture (No in step S101), the motion vector prediction application determining unit 13 determines that the col picture is not to be selected from among the reference pictures in the direction L1. Then, the motion vector prediction application determining unit 13 examines the picture type of each of the reference pictures located in the direction L0 as seen from the current picture, and the positional relationship between the decoding starting point and each of the reference pictures (step S104). When the picture type of at least one of the reference pictures in the direction L0 matches the picture type of the current picture, and when the reference picture is later in encoding order than the decoding starting picture immediately preceding the current picture (Yes in step S104), the motion vector prediction application determining unit 13 determines that the third motion vector prediction value candidate is to be used. Then, the motion vector prediction application determining unit 13 sets the parameter CollocatedFromL0Flag, which is carried in the slice header of the current picture and indicates the direction from which the col picture is to be selected, to “1” indicating that the col picture is to be selected from among the reference pictures located in the direction L0. Further, the motion vector prediction application determining unit 13 sets the parameter CollocatedRefIdx, which indicates the order among the reference pictures, to the minimum value min(RefIdex) of RefIndex to point to the picture nearest to the current picture in display order among the reference pictures of the same picture type as the current picture. Further, the motion vector prediction application determining unit 13 sets the parameter SliceTemporalMvpEnableFlag, which indicates whether the third motion vector prediction value candidate is to be used or not, to the value “1” indicating that the third motion vector prediction value candidate is to be used (step S105). Then, the motion vector prediction application determining unit 13 passes the parameters CollocatedFromL0Flag, CollocatedRefIdx, and SliceTemporalMvpEnableFlag to the motion vector information computing unit 14 as the result of the determination indicating that the third motion vector prediction value candidate is to be used.

The motion vector information computing unit 14 predicts the motion vector by using the third motion vector prediction value candidate in accordance with the AMVP method for each block to be inter-predictive encoded in the current picture, and predictive-encodes the motion vector by computing the prediction error (Step S106). The motion vector information computing unit 14 passes the motion vector prediction error, selected candidate index, and SliceTemporalMvpEnableFlag to the entropy encoding unit 15. Then, the motion vector information computing unit 14 terminates the motion vector predictive encoding process.

When, in step S104, none of the reference pictures in the direction L0 match the picture type of the current picture, or when there are no reference pictures in the direction L0 that are later in encoding order than the decoding starting picture immediately preceding the current picture (No in step S104), the motion vector prediction application determining unit 13 determines that the third motion vector prediction value candidate is not to be used for motion vector prediction. Therefore, the motion vector prediction application determining unit 13 sets the parameter SliceTemporalMvpEnableFlag to the value “0” indicating that the third motion vector prediction value candidate is not to be used (step S107). Then, the motion vector prediction application determining unit 13 passes the parameter SliceTemporalMvpEnableFlag to the motion vector information computing unit 14 as the result of the determination indicating that the third motion vector prediction value candidate is not to be used.

The motion vector information computing unit 14 predicts the motion vector without using the third motion vector prediction value candidate in accordance with the AMVP method for each block to be inter-predictive encoded in the current picture, and predictive-encodes the motion vector by computing the prediction error (Step S108). The motion vector information computing unit 14 passes the motion vector prediction error, selected candidate index, and SliceTemporalMvpEnableFlag to the entropy encoding unit 15. Then, the motion vector information computing unit 14 terminates the motion vector predictive encoding process.

The entropy encoding unit 15 entropy-encodes the quantized prediction error transform coefficients received from the source encoding unit 12 and the motion vector prediction error, selected candidate index, and SliceTemporalMvpEnableFlag received from the motion vector information computing unit 14. Thus, the entropy encoding unit 15 generates encoded video data which is obtained by encoding the input video. Then, the entropy encoding unit 15 outputs the encoded video data.

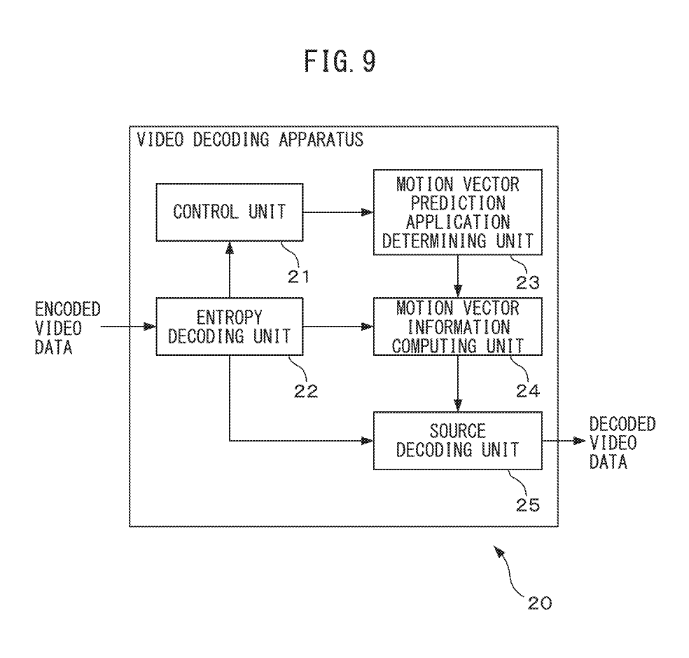

FIG. 9 is a diagram schematically illustrating the configuration of a video decoding apparatus according to the first embodiment. The video decoding apparatus decodes the encoded video data generated by the video encoding apparatus of the first embodiment. For this purpose, the video decoding apparatus 20 includes a control unit 21, an entropy decoding unit 22, a motion vector prediction application determining unit 23, a motion vector information computing unit 24, and a source decoding unit 25. These units of the video decoding apparatus 20 are implemented as separate circuits on the video decoding apparatus 20. Alternatively, these units of the video decoding apparatus 20 may be implemented on the video decoding apparatus 20 in the form of a single integrated circuit on which the circuits implementing the functions of the respective units are integrated. Further alternatively, these units of the video decoding apparatus 20 may be implemented as functional modules by executing a computer program on a processor incorporated in the video decoding apparatus 20.

The control unit 21 passes the slice header information received from the entropy decoding unit to the motion vector prediction application determining unit 23 and the source decoding unit 25.

The entropy decoding unit 22 entropy-decodes the encoded video data input to it. The entropy decoding unit 22 notifies the control unit 21 of the encoding mode (inter-predictive encoding mode or intra-predictive encoding mode), display order, reference relation, and picture type (frame or field) of each picture contained in the encoded video data.

Further, the entropy decoding unit 22 passes the motion vector prediction error, selected candidate index, and SliceTemporalMvpEnableFlag to the motion vector information computing unit 24. The entropy decoding unit 22 supplies the quantized prediction error transform coefficients and the encoding parameters to the source decoding unit 25.

The motion vector prediction application determining unit 23 determines whether or not the third motion vector prediction value candidate is to be used for motion vector encoding, based on the picture type of the current picture, the picture type of the reference picture, and SliceTemporalMvpEnableFlag. The motion vector prediction application determining unit 23 passes the result of the determination to the motion vector information computing unit 24.

The motion vector information computing unit 24 determines, from among the first, second, and third motion vector prediction value candidates, the candidate to be used for motion vector prediction. Then, the motion vector information computing unit 24 determines the motion vector prediction value in accordance with the AMVP process, based on the selected candidate index received from the entropy decoding unit 22, the result of the determination made by the motion vector prediction application determining unit 23 as to whether the third motion vector prediction value candidate is to be used or not, and the already decoded motion vector selected as the motion vector prediction value candidate. More specifically, the motion vector information computing unit 24 creates a list containing two of the first to third motion vector prediction value candidates, as in the video encoding apparatus 10, and determines the motion vector prediction value by selecting the candidate indicated by the selected candidate index from the list. Then, the motion vector information computing unit 24 decodes the motion vector by adding the motion vector prediction error to the motion vector prediction value. On the other hand, when the result of the determination received from the motion vector prediction application determining unit 23 indicates that the third motion vector prediction value candidate is not be used, the motion vector information computing unit 24 does not compute the third motion vector prediction value candidate, but determines the motion vector prediction value from among the first and second motion vector prediction value candidates. The motion vector information computing unit 24 passes the decoded motion vector to the source decoding unit 25.

The source decoding unit 25 performs source decoding by using the quantized prediction error transform coefficients and encoding parameters received from the entropy decoding unit 22 and the motion vector received from the motion vector information computing unit 24. More specifically, the source decoding unit 25 inverse-quantizes the quantized prediction error transform coefficients by multiplying with a predetermined number corresponding to the quantization step size. By this inverse quantization, the prediction error transform coefficients of the current block are reconstructed. After that, the source decoding unit 25 applies an inverse orthogonal transform to the prediction error transform coefficients. By applying the inverse quantization and inverse orthogonal transform to the quantized signals, the prediction error signal is reconstructed.

The source decoding unit 25 adds, to the value of each pixel in the prediction block, the reconstructed prediction error signal corresponding to the pixel. The source decoding unit 25 decodes each block by applying the above-described processing operations to the block. When the block is an inter-predictive encoded block, the prediction block is created by using a previously decoded picture and the decoded motion vector. Then, the source decoding unit 25 decodes the picture, for example, by splicing the blocks in the encoding order. The decoded picture is output to an external device for display; at the same time, the decoded picture is stored in a frame memory (not depicted), and is used to generate a prediction block for a block yet to be decoded in the picture being decoded, or to generate a prediction block for a subsequent picture.

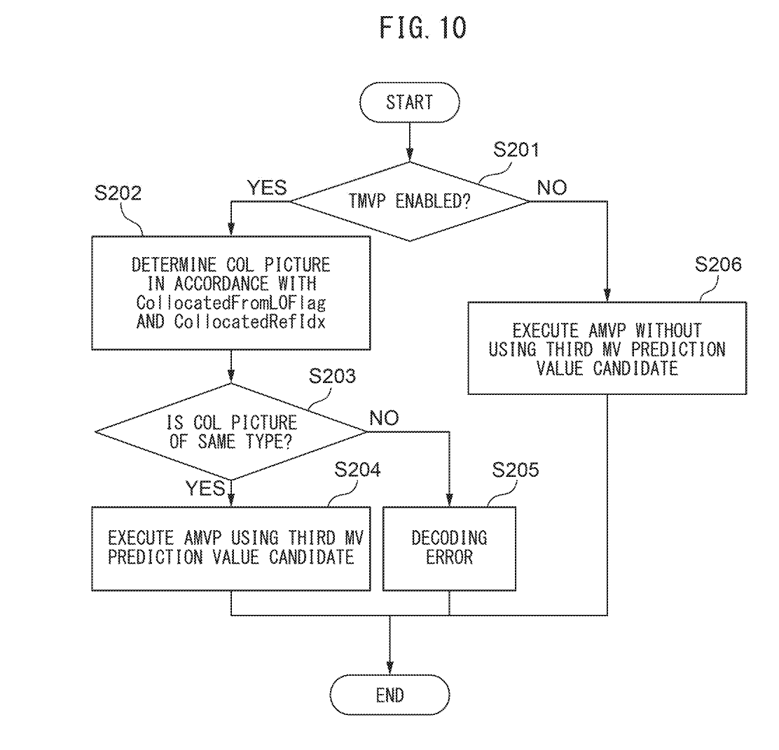

FIG. 10 is an operation flowchart of a motion vector decoding process according to the first embodiment. The video decoding apparatus 20 decodes the motion vector in accordance with the operation flowchart of FIG. 10 for each inter-predictive encoded picture to be decoded.

The motion vector prediction application determining unit 23 checks to see if the parameter SliceTemporalMvpEnableFlag, which indicates whether or not the third motion vector prediction value candidate is to be used, is set to the value “1” indicating that the third motion vector prediction value candidate is to be used (step S201). When the value of the parameter SliceTemporalMvpEnableFlag is “1” (Yes in step S201), the motion vector prediction application determining unit 23 determines the col picture in accordance with the parameter CollocatedFromL0Flag indicating the reference direction and the parameter CollocatedRefIdx indicating the position of the reference picture (step S202). Then, the motion vector prediction application determining unit 23 determines whether the picture type of the current picture to be decoded is the same as the picture type of the col picture (step S203). When the picture type of the current picture to be decoded is the same as the picture type of the col picture (Yes in step S203), the motion vector prediction application determining unit 23 notifies the motion vector information computing unit 24 of the result of the determination indicating that the third motion vector prediction value candidate is to be used. The motion vector information computing unit 24 determines the motion vector prediction value by using the third motion vector prediction value candidate in accordance with the AMVP method for each block in the current picture to be encoded, and decodes the motion vector based on the determined motion vector prediction value (step S204). After that, the motion vector information computing unit 24 terminates the motion vector decoding process.

On the other hand, when the picture type of the current picture in step S203 is different from the picture type of the col picture (No in step S203), the motion vector prediction application determining unit 23 notifies the control unit 21 of a decoding error (step S205). After that, the motion vector prediction application determining unit 23 terminates the motion vector decoding process.

On the other hand, when the value of the parameter SliceTemporalMvpEnableFlag in step S201 is “0” indicating that the third motion vector prediction value candidate is not to be used (No in step S201), the motion vector prediction application determining unit 23 notifies the motion vector information computing unit 24 of the result of the determination indicating that the third motion vector prediction value candidate is not to be used. The motion vector information computing unit 24 determines the motion vector prediction value without using the third motion vector prediction value candidate in accordance with the AMVP method for each block in the current picture to be decoded, and decodes the motion vector based on the determined motion vector prediction value (step S206). After that, the motion vector information computing unit 24 terminates the motion vector decoding process.

As has been described above, the video encoding apparatus according to the present embodiment can substantially prevent the degradation of the motion vector predictive coding efficiency, while maintaining the compatibility between the existing method and the AMVP method, even in the case of video data in which switching can be made between a frame picture and a field picture on a picture-by-picture basis. On the other hand, the video decoding apparatus according to the present embodiment can decode the video data encoded by the video encoding apparatus according to the present embodiment.

Next, a video encoding apparatus and a video decoding apparatus according to a second embodiment will be described. The video decoding apparatus according to the second embodiment determines whether or not the third motion vector prediction value candidate is to be used for motion vector encoding, based on the picture type of the picture to be decoded, the picture type of the col picture, etc., without referring to the parameter SliceTemporalMvpEnableFlag. Therefore, the video encoding apparatus according to the second embodiment does not use the parameter SliceTemporalMvpEnableFlag as an index that indicates whether or not to use the third motion vector prediction value candidate for motion vector encoding.

The video encoding apparatus according to the second embodiment differs from the video encoding apparatus according to the first embodiment in the operation of the control unit 11, the motion vector prediction application determining unit 13, and the entropy encoding unit 15. The following description therefore deals with the control unit 11, the motion vector prediction application determining unit 13, and the entropy encoding unit 15. For the other elements of the video encoding apparatus of the second embodiment, refer to the description earlier given of the corresponding elements of the video encoding apparatus of the first embodiment.

The control unit 11 notifies the motion vector prediction application determining unit 13 and the entropy encoding unit 15 of the value of the parameter SliceTemporalMvpEnableFlag. The control unit 11 sets the value of the parameter SliceTemporalMvpEnableFlag to “0” only when the current picture to be encoded is the decoding starting picture, and to “1” when it is not.

When the value of the parameter SliceTemporalMvpEnableFlag received from the control unit 11 is “1”, the motion vector prediction application determining unit 13 compares the picture type of the current picture with the picture type of the col picture. Then, only when the picture types match, does the motion vector prediction application determining unit 13 determine that the third motion vector prediction value candidate is to be used for motion vector encoding. When the value of SliceTemporalMvpEnableFlag is “0”, or when the picture type of the current picture and the picture type of the col picture do not match, the motion vector prediction application determining unit 13 determines that the third motion vector prediction value candidate is not to be used for motion vector encoding. The motion vector prediction application determining unit 13 notifies the motion vector information computing unit 14 of the result of the determination.

The entropy encoding unit 15 entropy-encodes the parameter SliceTemporalMvpEnableFlag as it is received from the control unit 11.

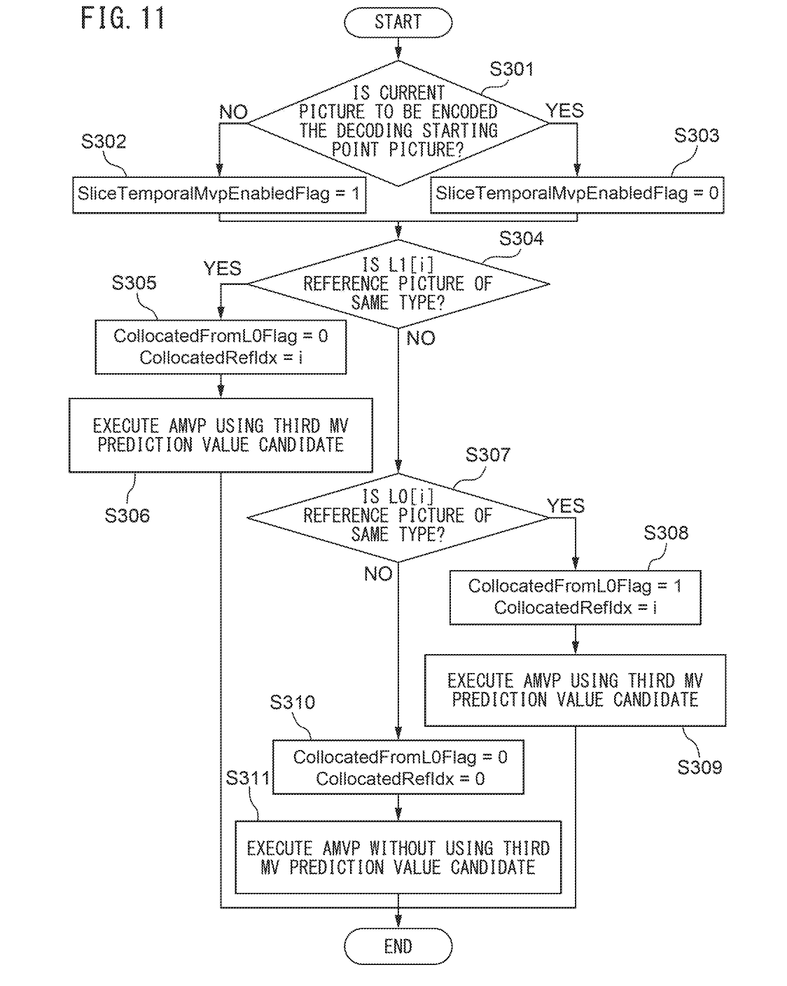

FIG. 11 is an operation flowchart of a motion vector predictive encoding process according to the second embodiment. The video encoding apparatus 10 predictive-encodes the motion vector in accordance with the operation flowchart of FIG. 11 for each picture to be inter-predictive encoded.

The control unit 11 determines whether the current picture to be encoded is the decoding starting picture or not (step S301). When the current picture is not the decoding starting picture (No in step S301), the control unit 11 sets the parameter SliceTemporalMvpEnableFlag to “1” (step S302). On the other hand, when the current picture is the decoding starting picture (Yes in step S301), the control unit 11 sets the parameter SliceTemporalMvpEnableFlag to “0” (step S303). After step S302 or S303, the control unit 11 notifies the motion vector prediction application determining unit 13 and the entropy encoding unit 15 of the value of the parameter SliceTemporalMvpEnableFlag.

The motion vector prediction application determining unit 13 compares the picture type (frame or field) of the current picture with the picture type of each of the reference pictures located in the direction L1 as seen from the current picture. Further, the motion vector prediction application determining unit 13 examines the positional relationship between the picture serving as the decoding starting point and each of the reference pictures located in the direction L1 (step S304). When the picture type of at least one of the reference pictures in the direction L1 matches the picture type of the current picture, and when the reference picture is later in encoding order than the decoding starting picture immediately preceding the current picture (Yes in step 304), the motion vector prediction application determining unit 13 determines that the third motion vector prediction value candidate is to be used. Then, the motion vector prediction application determining unit 13 sets the parameter CollocatedFromL0Flag, which is carried in the slice header of the current picture and indicates the direction from which the col picture is to be selected, to “0” indicating that the col picture is to be selected from among the reference pictures located in the direction L1. Further, the motion vector prediction application determining unit 13 sets the parameter CollocatedRefIdx, which indicates the order among the reference pictures, to the minimum value min(RefIdex) of RefIndex to point to the picture nearest to the current picture in display order among the reference pictures of the same picture type as the current picture. Then, the motion vector prediction application determining unit 13 passes the parameters CollocatedFromL0Flag and CollocatedRefIdx to the motion vector information computing unit 14 as the result of the determination indicating that the third motion vector prediction value candidate is to be used.

The motion vector information computing unit 14 predicts the motion vector by using the third motion vector prediction value candidate in accordance with the AMVP method for each block to be inter-predictive encoded in the current picture, and predictive-encodes the motion vector by computing the prediction error (Step S306). The motion vector information computing unit 14 passes the motion vector prediction error and the selected candidate index to the entropy encoding unit 15. Then, the motion vector information computing unit 14 terminates the motion vector predictive encoding process.

When, in step S304, none of the reference pictures in the direction L1 match the picture type of the current picture, or when there are no reference pictures in the direction L1 that are later in encoding order than the decoding starting picture immediately preceding the current picture (No in step S304), the motion vector prediction application determining unit 13 determines that the col picture is not to be selected from among the reference pictures in the direction L1. Then, the motion vector prediction application determining unit 13 examines the picture type of each of the reference pictures located in the direction L0 as seen from the current picture, and the positional relationship between the decoding starting point and each of the reference pictures (step S307). When the picture type of at least one of the reference pictures in the direction L0 matches the picture type of the current picture, and when the reference picture is later in encoding order than the decoding starting picture immediately preceding the current picture (Yes in step S307), the motion vector prediction application determining unit 13 determines that the third motion vector prediction value candidate is to be used. Then, the motion vector prediction application determining unit 13 sets the parameter CollocatedFromL0Flag to “1” indicating that the col picture is to be selected from among the reference pictures located in the direction L0. Further, the motion vector prediction application determining unit 13 sets the parameter CollocatedRefIdx, which indicates the order among the reference pictures, to the minimum value min(RefIdex) of RefIndex to point to the picture nearest to the current picture in display order among the reference pictures of the same picture type as the current picture. Then, the motion vector prediction application determining unit 13 passes the parameters CollocatedFromL0Flag and CollocatedRefIdx to the motion vector information computing unit 14 as the result of the determination indicating that the third motion vector prediction value candidate is to be used.

The motion vector information computing unit 14 predicts the motion vector by using the third motion vector prediction value candidate in accordance with the AMVP method for each block to be inter-predictive encoded in the current picture, and predictive-encodes the motion vector by computing the prediction error (Step S309). The motion vector information computing unit 14 passes the motion vector prediction error and the selected candidate index to the entropy encoding unit 15. Then, the motion vector information computing unit 14 terminates the motion vector predictive encoding process.

When, in step S307, none of the reference pictures in the direction L0 match the picture type of the current picture, or when there are no reference pictures in the direction L0 that are later in encoding order than the decoding starting picture immediately preceding the current picture (No in step S307), the motion vector prediction application determining unit 13 determines that the third motion vector prediction value candidate is not to be used for motion vector prediction. Therefore, the motion vector prediction application determining unit 13 sets the parameter CollocatedFromL0Flag to “0” and also sets the parameter CollocatedRefIdx to “0” (step S310). Then, the motion vector prediction application determining unit 13 passes the parameters CollocatedFromL0Flag and CollocatedRefIdx to the motion vector information computing unit 14 as the result of the determination indicating that the third motion vector prediction value candidate is not to be used.

The motion vector information computing unit 14 predicts the motion vector without using the third motion vector prediction value candidate in accordance with the AMVP method for each block to be inter-predictive encoded in the current picture, and predictive-encodes the motion vector by computing the prediction error (Step S311). The motion vector information computing unit 14 passes the motion vector prediction error and the selected candidate index to the entropy encoding unit 15. Then, the motion vector information computing unit 14 terminates the motion vector predictive encoding process.

Next, the video decoding apparatus according to the second embodiment will be described. The video decoding apparatus according to the second embodiment differs from the video decoding apparatus according to the first embodiment in the operation of the motion vector prediction application determining unit 23. The following description therefore deals with the motion vector prediction application determining unit 23 and its related parts. For the other elements of the video decoding apparatus of the second embodiment, refer to the description earlier given of the corresponding elements of the video decoding apparatus of the first embodiment.

Whether or not to use the third motion vector prediction value candidate for motion vector prediction is determined by the motion vector prediction application determining unit 23 in the following manner.
When SliceTemporalMvpEnableFlag is “0”, the motion vector prediction application determining unit 23 determines that the third motion vector prediction value candidate is not to be used for determining the motion vector prediction value when decoding the motion vector in the picture to be decoded.
When SliceTemporalMvpEnableFlag is “1”, if the picture type of the picture to be decoded is the same as the picture type of the col picture, the motion vector prediction application determining unit 23 determines that the third motion vector prediction value candidate is to be used for determining the motion vector prediction value when decoding the motion vector. On the other hand, if the picture type of the picture to be decoded differs from the picture type of the col picture, the motion vector prediction application determining unit 23 determines that the third motion vector prediction value candidate is not to be used for determining the motion vector prediction value when decoding the motion vector in the picture to be decoded.

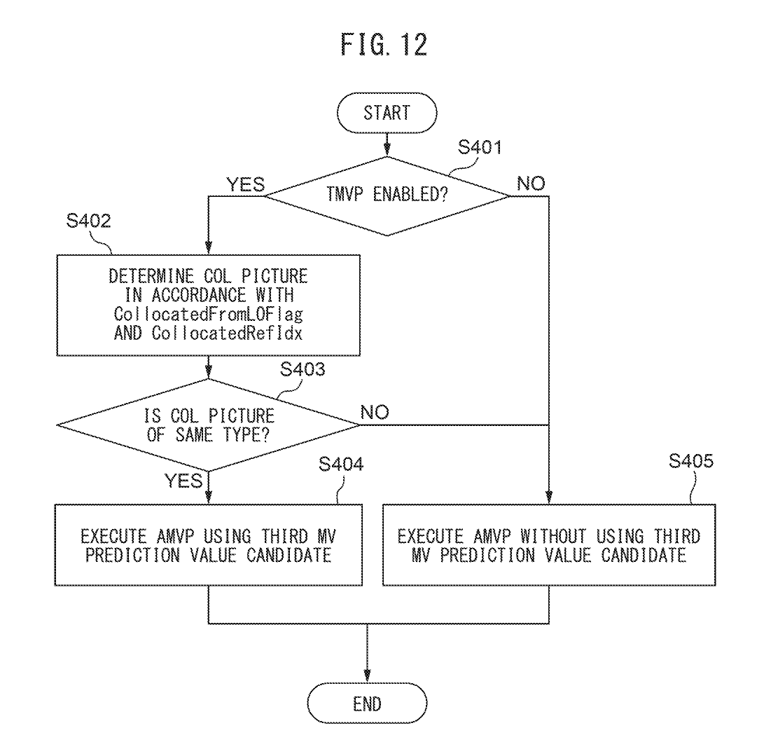

The process flow performed by the video decoding apparatus according to the second embodiment will be described with reference to FIG. 12. FIG. 12 is an operation flowchart illustrating the motion vector decoding process performed according to the second embodiment. The video decoding apparatus 20 decodes the motion vector in accordance with the operation flowchart of FIG. 12 for each inter-predictive encoded picture to be decoded.

The motion vector prediction application determining unit 23 checks to see if the parameter SliceTemporalMvpEnableFlag is set to “1” (step S401). When the value of the parameter SliceTemporalMvpEnableFlag is “1” (Yes in step S401), the motion vector prediction application determining unit 23 determines the col picture in accordance with the parameter CollocatedFromL0Flag indicating the reference direction and the parameter CollocatedRefIdx indicating the position of the reference picture (step S402). Then, the motion vector prediction application determining unit 23 determines whether the picture type of the current picture to be encoded is the same as the picture type of the col picture (step S403). When the picture type of the current picture is the same as the picture type of the col picture (Yes in step S403), the motion vector prediction application determining unit 23 notifies the motion vector information computing unit 24 of the result of the determination indicating that the third motion vector prediction value candidate is to be used. The motion vector information computing unit 24 determines the motion vector prediction value by using the third motion vector prediction value candidate in accordance with the AMVP method for each inter-predictive encoded block in the current picture to be decoded, and decodes the motion vector based on the determined motion vector prediction value (step S404). After that, the motion vector information computing unit 24 terminates the motion vector decoding process.

On the other hand, when the picture type of the current picture in step S403 is different from the picture type of the col picture (No in step S403), the motion vector prediction application determining unit 23 notifies the motion vector information computing unit 24 of the result of the determination indicating that the third motion vector prediction value candidate is not to be used. The motion vector information computing unit 24 determines the motion vector prediction value without using the third motion vector prediction value candidate in accordance with the AMVP method for each inter-predictive encoded block in the current picture to be decoded, and decodes the motion vector based on the determined motion vector prediction value (step S405). After that, the motion vector information computing unit 24 terminates the motion vector decoding process.

As has been described above, the video decoding apparatus according to the second embodiment can determine whether the third motion vector prediction value candidate is to be used or not, without referring to the parameter that the video encoding apparatus would set to indicate whether the third motion vector prediction value candidate is to be used or not. As a result, the video encoding apparatus and the video decoding apparatus can determine whether the third motion vector prediction value candidate is to be used or not, while using the parameter SliceTemporalMvpEnableFlag to point to the decoding starting picture as in the existing method.

According to a modified example, the motion vector prediction application determining unit 23 in the video decoding apparatus may be configured to not only determine whether or not to use the third motion vector prediction value candidate but also determine the col picture by performing a process similar to that of the motion vector prediction application determining unit 13 in the video encoding apparatus. In this case, the video encoding apparatus need not include information for identifying the col picture into the parameters CollocatedFromL0Flag and CollocatedRefIdx.

The video encoding apparatus and video decoding apparatus according to any one of the embodiments or its modified example are used in various applications. For example, the video encoding apparatus and video decoding apparatus are incorporated in a video camera, a video transmitting apparatus, a video receiving apparatus, a video telephone system, a computer, or a mobile telephone.

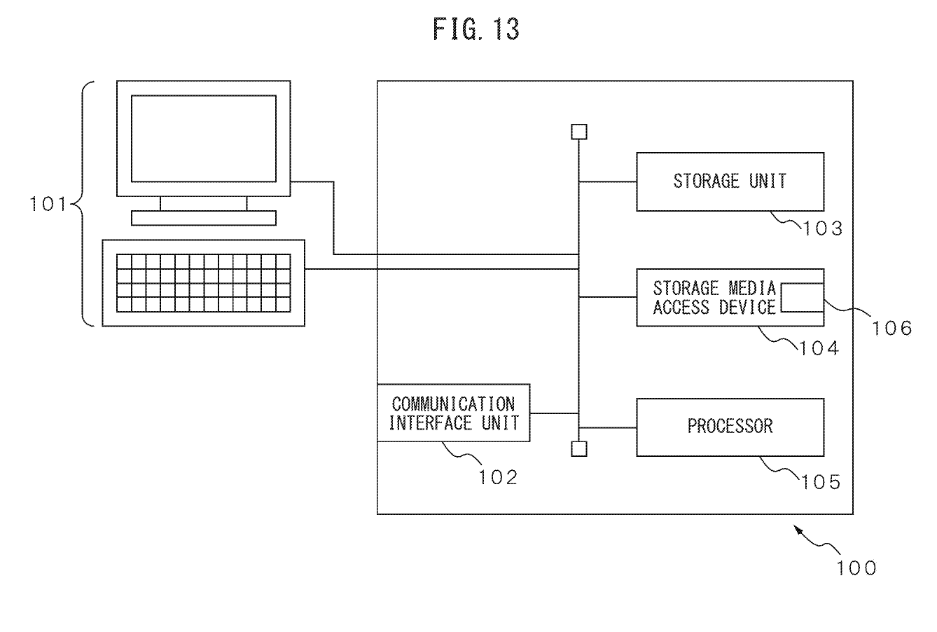

FIG. 13 is a diagram illustrating the configuration of a computer that operates as a video encoding apparatus or video decoding apparatus by executing a computer program for implementing the function of each unit of the video encoding apparatus or video decoding apparatus according to any one of the embodiments or its modified example.

The computer 100 includes a user interface unit 101, a communication interface unit 102, a storage unit 103, a storage media access device 104, and a processor 105. The processor 105 is connected to the user interface unit 101, communication interface unit 102, storage unit 103, and storage media access device 104, for example, via a bus.

The user interface unit 101 includes, for example, an input device such as a keyboard and mouse and a display device such as a liquid crystal display. Alternatively, the user interface unit 101 may include a device, such as a touch panel display, into which an input device and a display device are integrated. The user interface unit 101 generates, for example, in response to a user operation, an operation signal for selecting the video data to be encoded or the video data to be decoded, and supplies the operation signal to the processor 105. The user interface unit 101 may display decoded video data received from the processor 105.

The communication interface unit 102 may include a communication interface for connecting the computer 100 to a video data generating apparatus such as a video camera, and a control circuit for the communication interface. Such a communication interface may be, for example, a Universal Serial Bus (USB) interface.

Further, the communication interface unit 102 may include a communication interface for connecting to a communication network conforming to a communication standard such as the Ethernet (registered trademark), and a control circuit for the communication interface.

In this case, the communication interface unit 102 acquires video data to be encoded or encoded video data to be decoded from another apparatus connected to the communication network, and passes the data to the processor 105. The communication interface unit 102 may receive encoded video data or decoded video data from the processor 105 and may transmit the data to another apparatus via the communication network.

The storage unit 103 includes, for example, a readable/writable semiconductor memory and a read-only semiconductor memory. The storage unit 103 stores a computer program for implementing the video encoding process or video decoding process to be executed on the processor 105, and also stores data generated as a result of or during the execution of the program.

The storage media access device 104 is a device that accesses a storage medium 106 such as a magnetic disk, a semiconductor memory card, or an optical storage medium. The storage media access device 104 accesses the storage medium 106 to read out, for example, the video encoding or video decoding computer program to be executed on the processor 105, and passes the readout program to the processor 105.

The processor 105 generates encoded video data by executing the video encoding computer program according to any one of the embodiments or its modified example. The processor 105 stores the encoded video data in the storage unit 103, or transmits the encoded video data to another apparatus via the communication interface unit 102. Further, the processor 105 decodes the encoded video data by executing the video decoding computer program according to any one of the embodiments or its modified example. The processor 105 stores the decoded video data in the storage unit 103, displays the decoded video data on the user interface unit 101, or transmits the decoded video data to another apparatus via the communication interface unit 102.

A computer program executable on a processor to implement the function of each unit of the video encoding apparatus 10 may be provided in the form recorded on a computer readable recording medium. Likewise, a computer program executable on a processor to implement the function of each unit of the video decoding apparatus 20 may be provided in the form recorded on a computer readable recording medium. The term “recording medium” here does not include a carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that the various changes, substitutions, and alterations could be made hereto without departing from the spirit and scope of the invention.

What is claimed is:

1. A video encoding apparatus for inter-predictive encoding, using a motion vector, a picture that is contained in video data and whose picture type is a frame or a field, the video encoding apparatus comprising:
a processor configured to: when the picture type of the picture to be encoded matches the picture type of at least one of reference pictures that are referred to when inter-predictive encoding the picture, determine that the motion vector of a block contained in the at least one reference picture and having a predefined positional relationship to a block to be encoded in the picture to be encoded is to be included as a prediction value candidate for the motion vector of the block to be encoded, on the other hand, when the picture type of the picture to be encoded does not match the picture type of any one of the reference pictures, determine that the motion vector of any block in any one of the reference pictures is not to be included as a prediction value candidate for the motion vector of the block to be encoded;
determine, when the motion vector of a block contained in the at least one reference picture is included as a prediction value candidate for the motion vector of the block to be encoded, the prediction value candidate for the motion vector of the block to be encoded from among the motion vectors of a plurality of already encoded blocks in the picture being encoded and the motion vector of the block contained in the at least one reference picture and having the predefined positional relationship to the block to be encoded, on the other hand, when the motion vector of a block contained in the at least one reference picture is not included as a prediction value candidate for the motion vector of the block to be encoded, determine the prediction value candidate for the motion vector of the block to be encoded from among the motion vectors of a plurality of already encoded blocks in the picture being encoded, and a candidate whose difference with respect to the motion vector of the block to be encoded is the smallest among the prediction value candidates for the motion vector of the block to be encoded is selected as the prediction value for the motion vector of the block to be encoded;
generate selection information indicating the candidate that provides the prediction value;
compute the difference between the prediction value and the motion vector of the block to be encoded; and
entropy-encode the selection information and the difference between the prediction value and the motion vector of the block to be encoded.

2. The video encoding apparatus according to claim 1, wherein the at least one reference picture is a picture later in encoding order than a decoding starting picture immediately preceding the picture to be encoded.

3. The video encoding apparatus according to claim 1, wherein the processor further configured to: generate picture specifying information that specifies the at least one reference picture; and
entropy-encode the picture specifying information to include the entropy-encoded picture specifying information into encoded data of the video data.

4. The video encoding apparatus according to claim 1, wherein the processor further configured to: generate application information which indicates whether the motion vector of a block contained in the at least one reference picture is to be included as a prediction value candidate for the motion vector of the block to be encoded; and
entropy-encode the application information to include the entropy-encoded application information into encoded data of the video data.

5. The video encoding apparatus according to claim 4, wherein the application information is a flag, and the flag indicates whether a picture to which the flag is appended is the decoding starting picture or not.

6. A video decoding apparatus for decoding video data containing a picture that is inter-predictive encoded using a motion vector and whose picture type is a frame or a field, the video decoding apparatus comprising:
a processor configured to: decode entropy-encoded selection information that indicates a motion vector prediction value candidate that provides a prediction value for the motion vector of a block to be decoded;
decode an entropy-encoded difference between the prediction value and the motion vector of the block to be decoded;
when the picture type of the picture to be decoded, the picture containing the block to be decoded, matches the picture type of at least one of reference pictures that are referred to when inter-predictive encoding the picture to be decoded and that are decoded earlier than the picture to be decoded, determine that the motion vector of a block contained in the at least one reference picture and having a predefined positional relationship to the block to be decoded is to be included as a prediction value candidate for the motion vector of the block to be decoded, on the other hand, when the picture type of the picture to be decoded does not match the picture type of any one of the reference pictures, determine that the motion vector of any block in any one of the reference pictures is not to be included as a prediction value candidate for the motion vector of the block to be decoded;
determine, when the motion vector of a block contained in the at least one reference picture is included as a prediction value candidate for the motion vector of the block to be decoded, the prediction value candidate for the motion vector of the block to be decoded from among the motion vectors of a plurality of already decoded blocks in the picture being decoded and the motion vector of the block contained in the at least one reference picture and having the predefined positional relationship to the block to be decoded, on the other hand, determine, when the motion vector of a block contained in the at least one reference picture is not included as a prediction value candidate for the motion vector of the block to be decoded, the prediction value candidate for the motion vector of the block to be decoded from among the motion vectors of a plurality of already decoded blocks in the picture being decoded;
determine the candidate that provides the prediction value in accordance with the selection information from among the prediction value candidates for the motion vector of the block to be decoded;
decode the motion vector of the block to be decoded by adding the difference between the prediction value and the motion vector of the block to be decoded to the candidate that provides the prediction value; and
decode the block to be decoded by using the decoded motion vector.

7. The video decoding apparatus according to claim 6, wherein the at least one reference picture is a picture later in encoding order than a decoding starting picture immediately preceding the picture to be decoded.

8. The video decoding apparatus according to claim 6, wherein the inter-predictive encoded video data contains picture specifying information that specifies one of the reference pictures, and wherein
the processor further configured to: when the picture type of the reference picture specified by the picture specifying information is the same as the picture type of the picture to be decoded, determine that the motion vector of the block contained in the specified reference picture and having the predefined positional relationship to the block to be decoded is to be included as a prediction value candidate for the motion vector of the block to be decoded, on the other hand, when the picture type of the reference picture specified by the picture specifying information differs from the picture type of the picture to be decoded, determine that the motion vector of any block in any one of the reference pictures is not to be included as a prediction value candidate for the motion vector of the block to be decoded.

9. A video encoding method for inter-predictive encoding, using a motion vector, a picture that is contained in video data and whose picture type is either a frame or a field, the video encoding method comprising:
when the picture type of the picture to be encoded matches the picture type of at least one of reference pictures that are referred to when inter-predictive encoding the picture, determining, by a processor, that the motion vector of a block contained in the at least one reference picture and having a predefined positional relationship to a block to be encoded in the picture to be encoded is to be included as a prediction value candidate for the motion vector of the block to be encoded, on the other hand, when the picture type of the picture to be encoded does not match the picture type of any one of the reference pictures, determining, by the processor, that the motion vector of any block in any one of the reference pictures is not to be included as a prediction value candidate for the motion vector of the block to be encoded;
determining, by the processor, when the motion vector of a block contained in the at least one reference picture is included as a prediction value candidate for the motion vector of the block to be encoded, the prediction value candidate for the motion vector of the block to be encoded from among the motion vectors of a plurality of already encoded blocks in the picture being encoded and the motion vector of the block contained in the at least one reference picture and having the predefined positional relationship to the block to be encoded, on the other hand, determining, by the processor, when the motion vector of a block contained in the at least one reference picture is not included as a prediction value candidate for the motion vector of the block to be encoded, the prediction value candidate for the motion vector of the block to be encoded from among the motion vectors of a plurality of already encoded blocks in the picture being encoded;
selecting, by the processor, a candidate whose difference with respect to the motion vector of the block to be encoded is the smallest among the prediction value candidates for the motion vector of the block to be encoded as the prediction value for the motion vector of the block to be encoded;
generating, by the processor, selection information indicating the candidate that provides the prediction value and computing the difference between the prediction value and the motion vector of the block to be encoded; and
entropy-encoding, by the processor, the selection information and the difference between the prediction value and the motion vector of the block to be encoded.

10. The video encoding method according to claim 9, wherein the at least one reference picture is a picture later in encoding order than a decoding starting picture immediately preceding the picture to be encoded.

11. The video encoding method according to claim 9, further comprising: generating, by the processor, picture specifying information that specifies the at least one reference picture; and
entropy-encoding, by the processor, the picture specifying information to include the entropy-encoded picture specifying information into encoded data of the video data.

12. The video encoding method according to claim 9, further comprising: generating, by the processor, application information which indicates whether the motion vector of a block contained in the at least one reference picture is to be included as a prediction value candidate for the motion vector of the block to be encoded; and
entropy-encoding, by the processor, the application information to include the entropy-encoded application information into encoded data of the video data.

13. The video encoding method according to claim 12, wherein the application information is a flag, and the flag indicates whether a picture to which the flag is appended is the decoding starting picture or not.

14. A video decoding method for decoding video data containing a picture that is inter-predictive encoded using a motion vector and whose picture type is a frame or a field, the video decoding method comprising:
decoding, by a processor, entropy-encoded selection information that indicates a motion vector prediction value candidate that provides a prediction value for the motion vector of a block to be decoded, and also decoding an entropy-encoded difference between the prediction value and the motion vector of the block to be decoded;
when the picture type of the picture to be decoded, the picture containing the block to be decoded, matches the picture type of at least one of reference pictures that are referred to when inter-predictive encoding the picture to be decoded and that are decoded earlier than the picture to be decoded, determining, by the processor, that the motion vector of a block contained in the at least one reference picture and having a predefined positional relationship to the block to be decoded is to be included as a prediction value candidate for the motion vector of the block to be decoded, on the other hand, when the picture type of the picture to be decoded does not match the picture type of any one of the reference pictures, determining, by the processor, that the motion vector of any block in any one of the reference pictures is not to be included as a prediction value candidate for the motion vector of the block to be decoded;
determining, by the processor, when the motion vector of a block contained in the at least one reference picture is included as a prediction value candidate for the motion vector of the block to be decoded, the prediction value candidate for the motion vector of the block to be decoded from among the motion vectors of a plurality of already decoded blocks in the picture being decoded and the motion vector of the block contained in the at least one reference picture and having the predefined positional relationship to the block to be decoded, on the other hand, determining, by the processor, when the motion vector of a block contained in the at least one reference picture is not included as a prediction value candidate for the motion vector of the block to be decoded, the prediction value candidate for the motion vector of the block to be decoded from among the motion vectors of a plurality of already decoded blocks in the picture being decoded;
determining, by the processor, the candidate that provides the prediction value in accordance with the selection information from among the prediction value candidates for the motion vector of the block to be decoded;
decoding, by the processor, the motion vector of the block to be decoded by adding the difference between the prediction value and the motion vector of the block to be decoded to the candidate that provides the prediction value; and
decoding, by the processor, the block to be decoded by using the decoded motion vector.

15. The video decoding method according to claim 14, wherein the at least one reference picture is a picture later in encoding order than a decoding starting picture immediately preceding the picture to be decoded.

16. The video decoding method according to claim 14, wherein the inter-predictive encoded video data contains picture specifying information that specifies one of the reference pictures, and further comprising: when the picture type of the reference picture specified by the picture specifying information is the same as the picture type of the picture to be decoded, determining, by the processor, that the motion vector of the block contained in the specified reference picture and having the predefined positional relationship to the block to be decoded is to be included as a prediction value candidate for the motion vector of the block to be decoded, on the other hand, when the picture type of the reference picture specified by the picture specifying information differs from the picture type of the picture to be decoded, determining, by the processor, that the motion vector of any block in any one of the reference pictures is not to be included as a prediction value candidate for the motion vector of the block to be decoded.
